(19) United States
(12) Patent Application Publication
(10) Pub. No.: US 2026/0197781 A1
(43) Pub. Date: Jul. 9, 2026

(54) LOW-POWER SYNCHRONIZATION SIGNALS BLOCK

(71) Applicant: Samsung Electronics Co., Ltd., Suwon-si (KR)

(72) Inventor: Hongbo Si, Allen, TX (US)

(21) Appl. No.: 19/415,693

(22) Filed: Dec. 10, 2025

Related U.S. Application Data
(60) Provisional application No. 63/742,700, filed on Jan. 7, 2025.

(51) Int. Cl. H04W 56/00; H04L 27/26; H04W 72/0453

(52) U.S. Cl. CPC H04W 56/0015; H04L 27/26025; H04W 72/0453

(57) ABSTRACT

Apparatuses and methods for a low-power synchronization signals (LP-SS) block A method performed by a user equipment (UE) in a wireless communication system includes determining a first structure of a first synchronization signal block (SSB), receiving the first SSB based on the first structure, identifying, based on the first SSB, an indication on whether a second SSB is present, and receiving the second SSB, in response to identification that the second SSB is present.

### CROSS-REFERENCE TO RELATED AND CLAIM OF PRIORITY

The present application claims priority under 35 U.S.C. § 119(e) to U.S. Provisional Patent Application No. 63/742,700 filed on Jan. 7, 2025, which is hereby incorporated by reference in its entirety.

### TECHNICAL FIELD

The present disclosure relates generally to wireless communication systems and, more specifically, the present disclosure is related to a method and apparatus for a low-power synchronization signals (LP-SS) block.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus for an LP-SS block.

In one embodiment, a user equipment (UE) is provided. The UE includes a processor configured to determine a first structure of a first synchronization signal block (SSB) and a transceiver operably coupled to the processor. The transceiver configured to receive the first SSB based on the first structure. The processor is further configured to identify, based on the first SSB, an indication on whether a second SSB is present. The transceiver is further configured to receive the second SSB in response to identification that the second SSB is present.

In another embodiment, a base station (BS) is provided. The BS includes a processor configured to determine a first structure of a first SSB and determine, based on the first SSB, an indication on whether a second SSB is present. The BS further includes a transceiver operably coupled to the processor. The transceiver is configured to transmit the first SSB based on the first structure and transmit the second SSB in response to determination that the second SSB is present.

In yet another embodiment, a method performed by a user equipment is provided. The method includes determining a first structure of a first SSB, receiving the first SSB based on the first structure, identifying, based on the first SSB, an indication on whether a second SSB is present, and receiving the second SSB, in response to identification that the second SSB is present.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example synchronization signals and physical broadcast channel (SS/PBCH) block composition according to embodiments of the present disclosure;

FIGS. 6A-6B illustrate example on/off keying (OOK) waveforms according to embodiments of the present disclosure;

FIG. 7 illustrates an example multiplexing of components in an LP-SS block (LP-SSB) using time-division multiplexing (TDM) according to embodiments of the present disclosure;

FIG. 8 illustrates an example multiplexing of components in an LP-SSB using frequency-division multiplexing (FDM) according to embodiments of the present disclosure;

FIG. 9 illustrates an example multiplexing of components in an LP-SSB using both TDM and FDM according to embodiments of the present disclosure;

FIG. 10 illustrates another example multiplexing of components in an LP-SSB using both TDM and FDM according to embodiments of the present disclosure; and

FIG. 11 illustrates an example method performed by a UE in a wireless communication system according to embodiments of the present disclosure.

### DETAILED DESCRIPTION

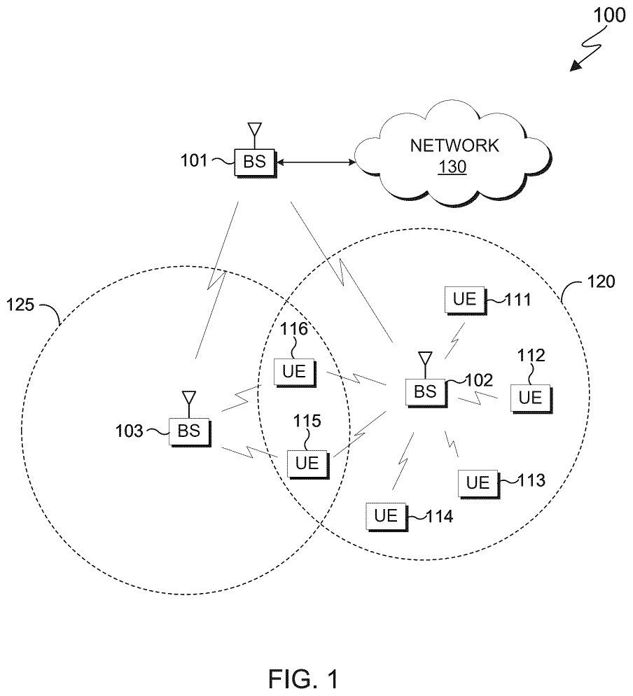

FIGS. 1-11 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v18.0.0, “NR; Physical channels and modulation” (herein, “REF 1”); 3GPP TS 38.212 v18.0.0, “NR; Multiplexing and channel coding” (herein, “REF 2”); 3GPP TS 38.213 v18.0.0, “NR; Physical layer procedures for control” (herein, “REF 3”); 3GPP TS 38.214 v18.0.0, “NR; Physical layer procedures for data” (herein, “REF 4”); and 3GPP TS 38.331 v18.0.0, “NR; Radio Resource Control (RRC) protocol specification” (herein, “REF 5”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing an LP-SS block. In certain embodiments, one or more of the gNBs 101-103 include circuitry, programing, or a combination thereof to implement an LP-SS block.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

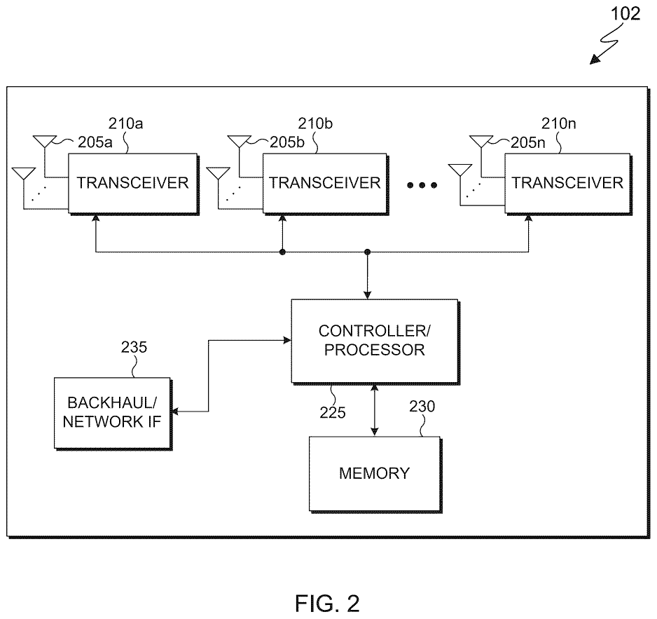

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for implementing an LP-SS block. Any of a wide variety of other functions could be supported in the gNB 102 by the controller/processor 225.

The controller/processor 225 is also capable of executing programs and other processes resident in the memory 230, such as processes to implement an LP-SS block. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

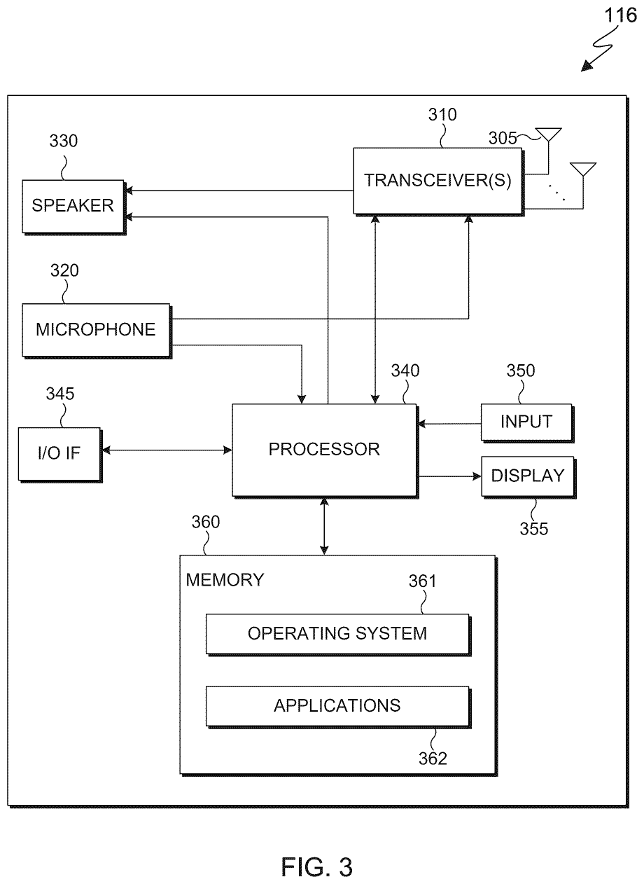

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing an LP-SS block as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

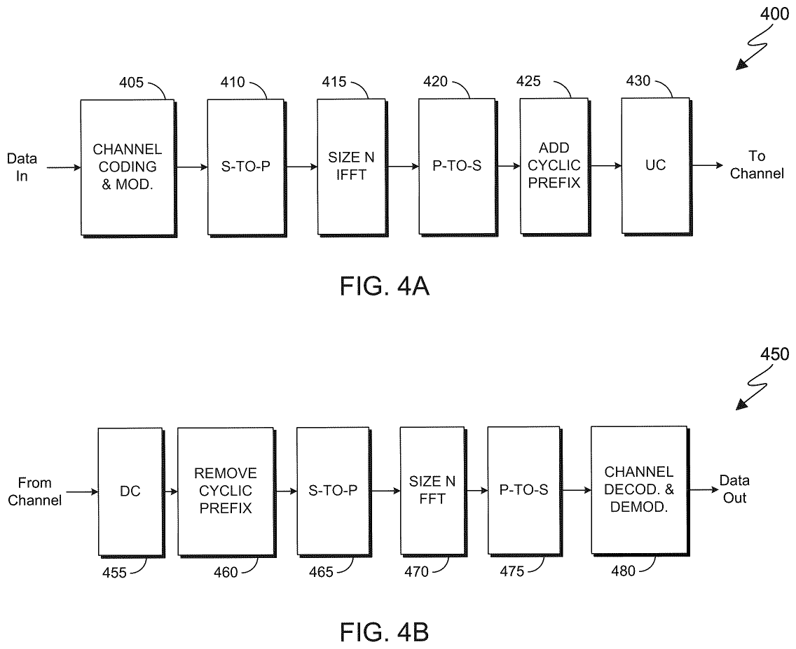

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for supporting an LP-SS block as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the gNBs 101-103 and may implement a receive path 450 for receiving in the downlink from the gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

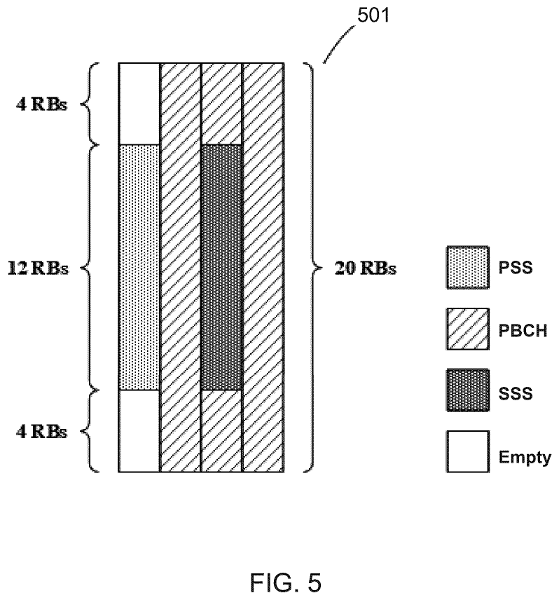

FIG. 5 illustrates an example SS/PBCH block composition 501 according to embodiments of the present disclosure. For example, SS/PBCH block composition 501 can be utilized by any of the UEs 111-116 of FIG. 1. This example is for illustration only and can be used without departing from the scope of the present disclosure.

In NR Rel-15, as illustrated in FIG. 5, each SS/PBCH block compromises of four consecutive OFDM symbols, wherein the center 12 resource blocks (RBs) of the first symbol are mapped for primary synchronization signal (PSS), the second and fourth symbols are mapped for PBCH, and the third symbol is mapped for both SSS and PBCH. In various embodiments, the same SS/PBCH composition is applied to all supported carrier frequency ranges in NR, which spans from 0.41 GHz to 7.125 GHz as Frequency Range 1 (FR1), and spans from 24.25 to 52.6 GHz as Frequency Range 2 (FR2). In every RB mapped for PBCH, 3 out of the 12 resource elements (REs) are mapped for the demodulation reference signal (DM-RS) of PBCH, wherein the 3 REs are uniformly distributed in the RB and the starting location of the first RE is based on cell identity (ID).

Further in NR Rel-19, an OOK waveform-based LP-SS was introduced, wherein the signal can be used for synchronization procedure and radio resource management (RRM) measurement by a low-power receiver (LR). For the OOK waveform, one OFDM symbol can include one or multiple OOK symbols, wherein each OOK symbol corresponds to either ON or OFF. The ON-OFF pattern provided by the OOK waveform can be determined by a binary sequence, and different binary sequences can carry information for the LP-SS.

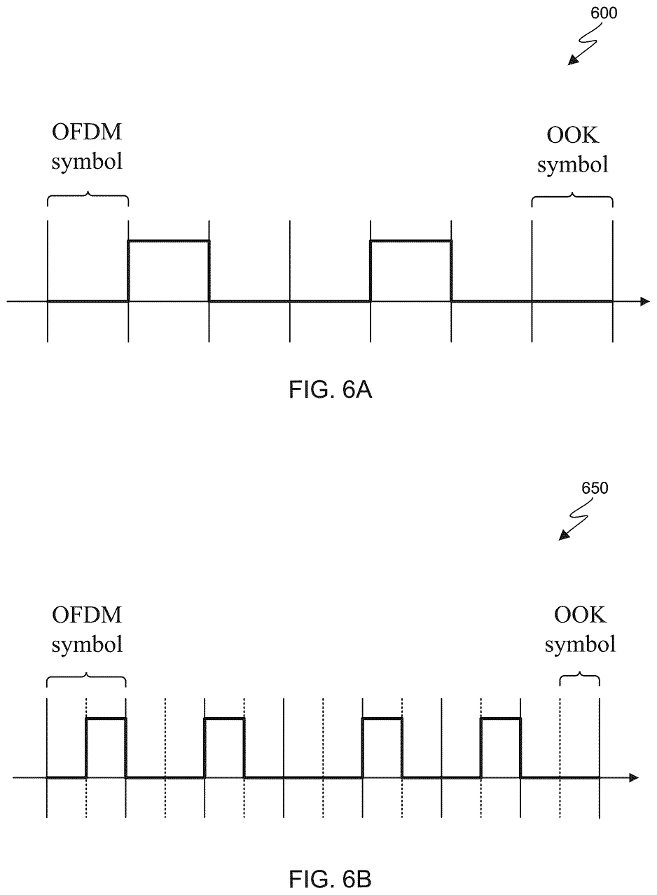

FIGS. 6A and 6B illustrate example OOK waveforms 600 and 650 according to embodiments of the present disclosure. For example, OOK waveforms 600 and 650 can be utilized by any of the UEs 111-116 of FIG. 1. This example is for illustration only and can be used without departing from the scope of the present disclosure.

As illustrated in FIG. 6A, example OOK waveform 600 may include one OOK symbol in an OFDM symbol. As illustrated in FIG. 6B, example OOK waveform 650 may include two OOK symbols in an OFDM symbol.

For the new generation of wireless communication, to save the energy of a UE, an LR can be used for initial access. For this purpose, LP-SS and/or a low power physical broadcast channel (LP-PBCH) can be supported. The present disclosure provides a design for an LP-SSB, which includes at least one low power synchronization signal, and may further include a low power physical broadcast channel.

Furthermore, the present disclosure provides a design for a first SSB, e.g., an LP-SSB, including the components included in the block and a multiplexing pattern of the components. More precisely, the following aspects are provided in the present disclosure:
Components in an LP-SSB
   LP-SS
   Low-power secondary synchronization signal (LP-SSS)
   LP-PBCH
Multiplexing of components in an LP-SSB
   TDM
   FDM
   Both TDM and FDM
Example UE procedure

In the present disclosure, the components in an LP-SSB are provided. In one embodiment, a set of signal(s) and/or channel(s) can be included to form an LP-SSB, wherein the set of signal(s) and/or channel(s) include at least an LP-SS.

For one example, the LP-SS can be a signal that can be generated using a waveform that enables low power reception at the UE, e.g., an OOK waveform such that it can be received at least by an LR, or an OFDM waveform such that it can be received at least by an LR; and/or using a waveform that enables low power transmission at the BS.

For one instance, the LP-SS can be used for synchronization purposes.

For another instance, the LP-SS can be used for measurement purposes, such as RRM measurement, or layer-1 (L1) measurement.

For yet another instance, the LP-SS can be generated based on a binary sequence, wherein e.g., when the LP-SS is based on OOK waveform, a bit taking value of 1 in the binary sequence corresponds to a OOK symbol taking as ON in the LP-SS; and the bit taking value of 0 in the binary sequence corresponds to the OOK symbol taking as OFF in the LP-SS, or e.g., when the LP-SS is based on OFDM waveform, the binary sequence is mapped to subcarriers for the LP-SS.

For yet another instance, the binary sequence for generating the LP-SS can be determined from a number (e.g., N_{LP-SS}) of candidate sequences in a cell, e.g., based on information carried by the LP-SS.
For one sub-instance, the number N_{LP-SS} can be fixed for a given cell, e.g., N_{LP-SS}=1, or 2, or 3, or 4, or 8.

For yet another instance, the information carried by the LP-SS can be based on a physical cell identification (ID) of the cell where the LP-SS is transmitted, i.e., identical to the physical cell ID, or part of the cell ID such as └N_{ID}/(N_{ID,total}/N_{LP-SS})┘ or (N_{ID} mod N_{LP-SS}), wherein N_{ID} is the physical cell ID and N_{ID,total} is the number of physical cell IDs.

For yet another instance, the information carried by the LP-SS can be configured by a higher layer parameter, such as a system information block (SIB) or a dedicated RRC parameter.

For another example, another synchronization signal (e.g., in addition to LP-SS) can be included in the LP-SSB, e.g., being referred to as the LP-SSS.

For one instance, when the LP-SSS is included in the LP-SSB, LP-SS can also be referred to as a low-power primary synchronization signal (LP-PSS).

For another instance, the LP-SSS can be a signal that can be generated using a waveform that enables low power reception at the UE, e.g., an OOK waveform such that it can be received at least by an LR, or an OFDM waveform such that it can be received at least by an LR; and/or using a waveform that enables low power transmission at the BS.

For yet another instance, the LP-SSS can be used for synchronization purposes.

For yet another instance, the LP-SSS can be used for measurement purposes, such as RRM measurement, or L1 measurement.

For yet another instance, the LP-SSS can be generated based on a binary sequence, wherein e.g., when the LP-SSS is based on OOK waveform, a bit taking value of 1 in the binary sequence corresponds to a OOK symbol taking as ON in the LP-SSS; and the bit taking value of 0 in the binary sequence corresponds to the OOK symbol taking as OFF in the LP-SSS, or e.g., when the LP-SSS is based on OFDM waveform, the binary sequence is mapped to subcarriers for the LP-SSS.

For yet another instance, the binary sequence for generating the LP-SSS can be determined from a number (e.g., N_{LP-SSS}) of candidate sequences in a cell, e.g., based on information carried by the LP-SSS.
For one sub-instance, the number N_{LP-SSS} can be fixed for a given cell.
For another sub-instance, N_{LP-SSS}>N_{LP-SS}.

For yet another instance, the LP-SSS can be generated based on a number

$$( e . g . , {N}_{LP - SSS}^{info} )$$

of information bits, e.g., the bits including the example information carried by the LP-SSS.
For one sub-instance, the number of information bits can be scrambled using a sequence. For one further consideration, the scrambling sequence can be generated based on information carried by the LP-SSS.
For another sub-instance, the number of information bits can be interleaved/re-ordered based on a mapping pattern. For one further consideration, the mapping pattern can be determined based on information carried by the LP-SSS.
For yet another sub-instance, the information bits can be attached with a cyclic redundancy check (CRC). For one further consideration, the CRC can be generated based on information carried by the LP-SSS.
For yet another sub-instance, the information bits can be encoded.

For yet another instance, the information carried by the LP-SSS can include information based on a physical cell ID of the cell where the LP-SSS is transmitted.
For one sub-instance, the information can be the remaining part of the physical cell ID from the one already carried by the LP-SS.
For another sub-instance, the information can be the whole physical cell ID.

For yet another instance, the information carried by the LP-SSS can include information related to timing.
For one sub-instance, the information can be system frame number (SFN) or part of the SFN (e.g., one or multiple most significant bit (MSB) of SFN, or one or multiple least significant bit (LSB) of SFN, or some particular bit(s) from SFN).
For another sub-instance, the information can be half frame index, e.g., an index indicating a first or a second half frame where the LP-SSS is located or starts or ends.
For yet another sub-instance, the information can be slot index, e.g., an index indicating a slot number where the LP-SSS is located or starts or ends.
For yet another sub-instance, the information can be OFDM symbol index, e.g., an index indicating a OFDM symbol number where the LP-SSS is located or starts or ends.

For yet another instance, the information carried by the LP-SSS can include information related to an index for the LP-SSB in a burst.
For one sub-instance, the information can be LP-SSB index or part of the LP-SSB index (e.g., one or multiple MSB of the LP-SSB index, or one or multiple LSB of the LP-SSB index), where the LP-SSB index corresponds to a time domain index of the LP-SSB within a burst of the LP-SSB.

For yet another instance, the information carried by the LP-SSS can include configuration or parameters for a second SSB, e.g., SS/PBCH block, wherein e.g., the SS/PBCH block is in the same cell or same carrier as the first SSB, e.g., LP-SSS.
For one sub-instance, the information can include time domain information on the resources for SS/PBCH block transmission, such as a SFN, half frame, slot, or OFDM symbol where the SS/PBCH block transmission is located or starts or ends.
For another sub-instance, the information can include frequency domain information on the resources for SS/PBCH block transmission, such as a frequency location of the SS/PBCH block, or a frequency offset to the LP-SSB, or an indication of a band or a carrier where the SS/PBCH block is located.
For yet another sub-instance, the information can include power domain information for SS/PBCH block transmission, such as the transmission power or energy per resource element (EPRE) of the SS/PBCH block, or an offset of the transmission power or EPRE with respect to the one of LP-SSB.

For yet another instance, the information carried by the LP-SSS can include configuration or parameters for the LP-PBCH, e.g., the LP-PBCH in the same LP-SSB.
For one sub-instance, the information can include whether the LP-PBCH is present or not in the same LP-SSB.
For another sub-instance, the information can include a multiplexing pattern of the LP-PBCH with the LP-SSS, such as a number of multiplexing patterns are pre-defined in the specification of system operation or provided by higher layer parameters, and one from the multiplexing patterns is indicated by the LP-SSS.

For yet another instance, the information carried by the LP-SSS can include cell baring information.

For yet another instance, the information carried by the LP-SSS can include an index of section or entity or component associated with the cell, wherein e.g., the section/entity/component can be a transmission reception point (TRP) or a carrier or a sub-band.

For yet another instance, the information carried by the LP-SSS can be configured by a higher layer parameter, such as an SIB or a dedicated RRC parameter.

For yet another example, an LP-PBCH can be included in the LP-SSB, e.g., can also be referred to as low-power system information block (LP-SIB).

For one instance, the LP-PBCH can be a signal that can be generated using a waveform that enables low power reception at the UE, e.g., an OOK waveform such that it can be received at least by an LR, or an OFDM waveform such that it can be received at least by an LR; and/or using a waveform that enables low power transmission at the BS.

For another instance, the LP-PBCH can be used for synchronization purposes.

For yet another instance, the LP-PBCH can be used for measurement purposes, such as RRM measurement, or L1 measurement.

For yet another instance, the LP-PBCH can be generated based on a binary sequence, wherein e.g., when the LP-PBCH is based on OOK waveform, a bit taking value of 1 in the binary sequence corresponds to a OOK symbol taking as ON in the LP-PBCH; and the bit taking value of 0 in the binary sequence corresponds to the OOK symbol taking as OFF in the LP-PBCH, or e.g., when the LP-PBCH is based on OFDM waveform, the binary sequence is mapped to subcarriers for the LP-PBCH.

For yet another instance, the binary sequence for generating the LP-PBCH can be determined from a number (e.g., N_{LP-PBCH}) of candidate sequences in a cell, e.g., based on information carried by the LP-PBCH.
For one sub-instance, the number N_{LP-PBCH} can be fixed for a given cell.
For another sub-instance, N_{LP-PBCH}>N_{LP-SS}.

For yet another instance, the LP-PBCH can be generated based on a number

$$( e . g . , {N}_{LP - PBCH}^{info} )$$

of information bits, e.g., the bits including the example information carried by the LP-PBCH.
For one sub-instance, the number of information bits can be scrambled using a sequence. For one further consideration, the scrambling sequence can be generated based on information carried by the LP-PBCH.
For another sub-instance, the number of information bits can be interleaved/re-ordered based on a mapping pattern. For one further consideration, the mapping pattern can be determined based on information carried by the LP-PBCH.
For yet another sub-instance, the information bits can be attached with a CRC check. For one further consideration, the CRC can be generated based on information carried by the LP-PBCH.
For yet another sub-instance, the information bits can be encoded.

For yet another instance, the information carried by the LP-PBCH can include information based on a physical cell ID of the cell where the LP-PBCH is transmitted.
For one sub-instance, the information can be the remaining part of the physical cell ID from the one already carried by the LP-PBCH.
For another sub-instance, the information can be the whole physical cell ID.

For yet another instance, the information carried by the LP-PBCH can include information related to timing.
For one sub-instance, the information can be SFN or part of the SFN (e.g., one or multiple MSB of SFN, or one or multiple LSB of SFN, or some particular bit(s) from SFN).
For another sub-instance, the information can be half frame index, e.g., an index indicating a first or a second half frame where the LP-PBCH is located or starts or ends.
For yet another sub-instance, the information can be slot index, e.g., an index indicating a slot number where the LP-PBCH is located or starts or ends.
For yet another sub-instance, the information can be OFDM symbol index, e.g., an index indicating a OFDM symbol number where the LP-PBCH is located or starts or ends.

For yet another instance, the information carried by the LP-PBCH can include information related to an index for the LP-SSB in a burst.
For one sub-instance, the information can be LP-SSB index, or part of the LP-SSB index (e.g., one or multiple MSB of the LP-SSB index, or one or multiple LSB of the LP-SSB index), or remaining LP-SSB index from the one carried by LP-SSS, where the LP-SSB index corresponds to a time domain index of the LP-SSB within a burst of the LP-SSB.

For yet another instance, the information carried by the LP-PBCH can include configuration or parameters for a second SSB, e.g., SS/PBCH block, wherein e.g., the SS/PBCH block is in the same cell or same carrier as the first SSB, e.g., LP-PBCH.
For one sub-instance, the information can include time domain information on the resources for SS/PBCH block transmission, such as a SFN, half frame, slot, or OFDM symbol where the SS/PBCH block transmission is located or starts or ends.
For another sub-instance, the information can include frequency domain information on the resources for SS/PBCH block transmission, such as a frequency location of the SS/PBCH block, or a frequency offset to the LP-SSB, or an indication of a band or a carrier where the SS/PBCH block is located.
For yet another sub-instance, the information can include power domain information for SS/PBCH block transmission, such as the transmission power or EPRE of the SS/PBCH block, or an offset of the transmission power or EPRE with respect to the one of LP-SSB.
For yet another sub-instance, the information can include whether an associated SS/PBCH block is transmitted (or present), e.g., using 1-bit indication.

For yet another instance, the information carried by the LP-PBCH can include cell baring information.
For one sub-instance, the information can include whether the cell allows a UE for accessing, e.g., using 1-bit indication.

For yet another instance, the information carried by the LP-PBCH can include whether the cell is associated with a first radio access technology (RAT) or a second RAT.
For one sub-instance, the first RAT can be 5G.
For another sub-instance, the second RAT can be 6G.

For yet another instance, the information carried by the LP-PBCH can include parameters related to on-demand system information block (e.g., SIB1).
For one sub-instance, the information can include time domain resources for monitoring PDCCH of the SIB1.
For another sub-instance, the information can include frequency domain resources for monitoring PDCCH of the SIB1.
For yet another sub-instance, the information can include time domain resources for PDSCH of the SIB1.
For yet another sub-instance, the information can include frequency domain resources for PDSCH of the SIB1.
For yet another sub-instance, the information can include information for the configuration of an uplink transmission for requesting the on-demand SIB1.

For yet another instance, the information carried by the LP-PBCH can include an index of section or entity or component associated with the cell, wherein e.g., the section/entity/component can be a transmission reception point (TRP) or a carrier or a sub-band.

For yet another instance, the information carried by the LP-PBCH can be configured by a higher layer parameter, such as an SIB or a dedicated RRC parameter.

In the present disclosure, multiplexing of components in an LP-SSB are provided. In one embodiment, an LP-SSB can include at least one component from the components described in the present disclosure.

For one consideration, there can be more than one example or sub-example in this disclosure supported for the LP-SSB, e.g., for different use cases. For one instance, at least one example or sub-example can be assumed by the UE for initial cell search, e.g., for a given band or a frequency range. For another instance, at least one example or sub-example can be configured by the BS using a higher layer parameter.

For another consideration, components in the same LP-SSB have a same subcarrier spacing.

For yet another consideration, when implemented with the OOK waveform, components in the same LP-SSB have a same value of M, where M corresponds to the number of segments (e.g., OOK symbols) included in one OFDM symbol.

For one example, components in the LP-SSB can be time division multiplexed (TDMed).

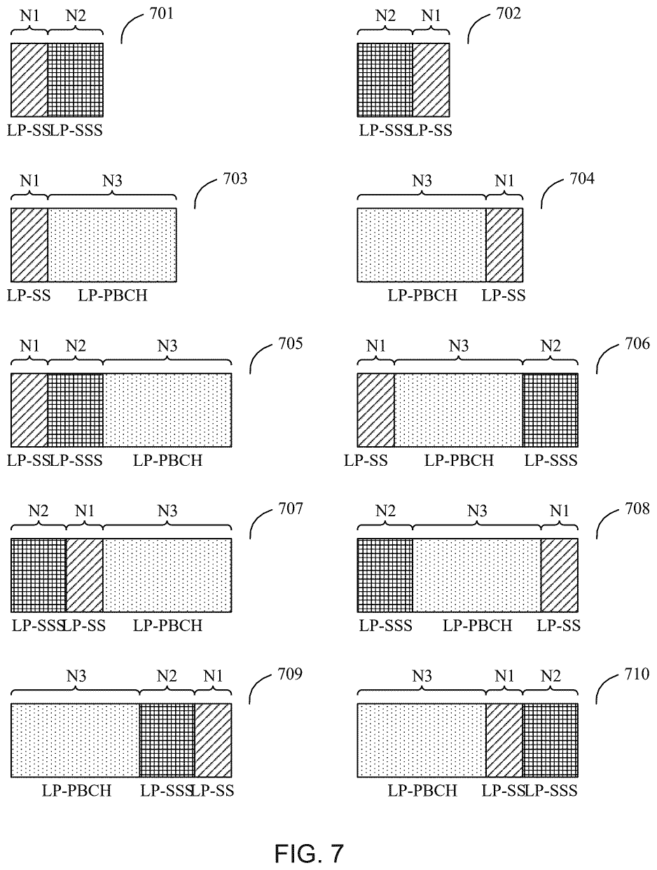

FIG. 7 illustrates an example multiplexing of components in an LP-SSB using TDM according to embodiments of the present disclosure. For example, TDM of components in an LP-SSB can be utilized by any of the UEs 111-116 of FIG. 1. This example is for illustration only and can be used without departing from the scope of the present disclosure.

For a first sub-example 701, as illustrated in FIG. 7, a LP-SSB consists of a LP-SS and a LP-SSS, as described in this disclosure, wherein the LP-SS and LP-SSS are TDMed, e.g., LP-SS occupies the first N1 symbols in the LP-SSB, and LP-SSS occupies the next N2 symbols in the LP-SSB.

For a second sub-example 702, a LP-SSB consists of a LP-SSS and a LP-SS, as described in this disclosure, wherein the LP-SSS and LP-SS are TDMed, e.g., LP-SSS occupies the first N2 symbols in the LP-SSB, and LP-SS occupies the next N1 symbols in the LP-SSB.

For a third sub-example 703, a LP-SSB consists of a LP-SS and a LP-PBCH, as described in this disclosure, wherein the LP-SS and LP-PBCH are TDMed, e.g., LP-SS occupies the first N1 symbols in the LP-SSB, and LP-PBCH occupies the next N3 symbols in the LP-SSB.

For a fourth sub-example 704, a LP-SSB consists of a LP-PBCH and a LP-SS, as described in this disclosure, wherein the LP-PBCH and LP-SS are TDMed, e.g., LP-PBCH occupies the first N3 symbols in the LP-SSB, and LP-SS occupies the next N1 symbols in the LP-SSB.

For a fifth sub-example 705, a LP-SSB consists of a LP-SS, a LP-SSS, and a LP-PBCH, as described in this disclosure, wherein the LP-SS, LP-SSS, and LP-PBCH are TDMed, e.g., LP-SS occupies the first N1 symbols in the LP-SSB, LP-SSS occupies the next N2 symbols in the LP-SSB, and LP-PBCH occupies the last N3 symbols in the LP-SSB.

For a sixth sub-example 706, a LP-SSB consists of a LP-SS, a LP-PBCH, and a LP-SSS, as described in this disclosure, wherein the LP-SS, LP-PBCH, and LP-SSS are TDMed, e.g., LP-SS occupies the first N1 symbols in the LP-SSB, LP-PBCH occupies the next N3 symbols in the LP-SSB, and LP-SSS occupies the last N2 symbols in the LP-SSB.

For a seventh sub-example 707, a LP-SSB consists of a LP-SSS, a LP-SS, and a LP-PBCH, as described in this disclosure, wherein the LP-SSS, LP-SS, and LP-PBCH are TDMed, e.g., LP-SSS occupies the first N2 symbols in the LP-SSB, LP-SS occupies the next N1 symbols in the LP-SSB, and LP-PBCH occupies the last N3 symbols in the LP-SSB.

For an eighth sub-example 708, a LP-SSB consists of a LP-SSS, a LP-PBCH, and a LP-SS, as described in this disclosure, wherein the LP-SSS, LP-PBCH, and LP-SS are TDMed, e.g., LP-SSS occupies the first N2 symbols in the LP-SSB, LP-PBCH occupies the next N3 symbols in the LP-SSB, and LP-SS occupies the last N1 symbols in the LP-SSB.

For a ninth sub-example 709, a LP-SSB consists of a LP-PBCH, a LP-SSS, and a LP-SS, as described in this disclosure, wherein the LP-PBCH, LP-SSS, and LP-SS are TDMed, e.g., LP-PBCH occupies the first N3 symbols in the LP-SSB, LP-SSS occupies the next N2 symbols in the LP-SSB, and LP-SS occupies the last N1 symbols in the LP-SSB.

For a tenth sub-example 710, a LP-SSB consists of a LP-PBCH, a LP-SS, and a LP-SSS, as described in this disclosure, wherein the LP-PBCH, LP-SS, and LP-SSS are TDMed, e.g., LP-PBCH occupies the first N3 symbols in the LP-SSB, LP-SS occupies the next N1 symbols in the LP-SSB, and LP-SSS occupies the last N2 symbols in the LP-SSB.

For one further consideration of the sub-examples of this example, the components (LP-SS, and/or LP-SSS, and/or LP-PBCH) can have same bandwidth, e.g., in term of RBs or subcarrier spacings.

For another further consideration of the sub-examples of this example, the unit of N1, and/or N2, and/or N3 can be either an OFDM symbol or an OOK symbol (e.g., a segment in an OFDM symbol that corresponds to an ON or an OFF in the OOK waveform).

For yet another further consideration of the sub-examples of this example, although the components are TDMed without time domain gap(s) in between, as illustrated in FIG. 7, this disclosure also includes a multiplexing pattern with potential time domain gap(s) in between components within the LP-SSB.

For yet another further consideration of the sub-examples of this example, N1=N2.

For yet another further consideration of the sub-examples of this example, N1=N3.

For yet another further consideration of the sub-examples of this example, N2=N3.

For yet another further consideration of the sub-examples of this example, N1 can be pre-defined in the specifications of system operation, such as N1=1, or N1=2, or N1=3, or N1=4, or N1=5, or N1=6, or N1=7, or N1=8, or N1=14.

For yet another further consideration of the sub-examples of this example, N1 can be configured by a higher layer parameter, such as a SIB or a dedicated RRC parameter.

For yet another further consideration of the sub-examples of this example, N2 can be pre-defined in the specifications of system operation, such as N2=1, or N2=2, or N2=3, or N2=4, or N2=5, or N2=6, or N2=7, or N2=8, or N2=14.

For yet another further consideration of the sub-examples of this example, N2 can be configured by a higher layer parameter, such as a SIB or a dedicated RRC parameter.

For yet another further consideration of the sub-examples of this example, N3 can be pre-defined in the specifications of system operation, such as N3=1, or N3=2, or N3=3, or N3=4, or N3=5, or N3=6, or N3=7, or N3=8, or N3=14.

For yet another further consideration of the sub-examples of this example, N3 can be configured by a higher layer parameter, such as a SIB or a dedicated RRC parameter.

For yet another further consideration of the sub-examples of this example, when the components of the LP-SSB are TDMed, the frequency domain resources for the components of the LP-SSB can be the same, e.g., occupying the same number of subcarriers or RBs. For one instance, the frequency domain resources (e.g., bandwidth) can be pre-defined in the specifications of system operation, e.g., 11 RBs, or 12 RBs. For another instance, the frequency domain resources (e.g., starting frequency location and/or bandwidth) can be configured by a higher layer parameter, such as a SIB or a dedicated RRC parameter.

For one example, components in the LP-SSB can be frequency division multiplexed (FDMed).

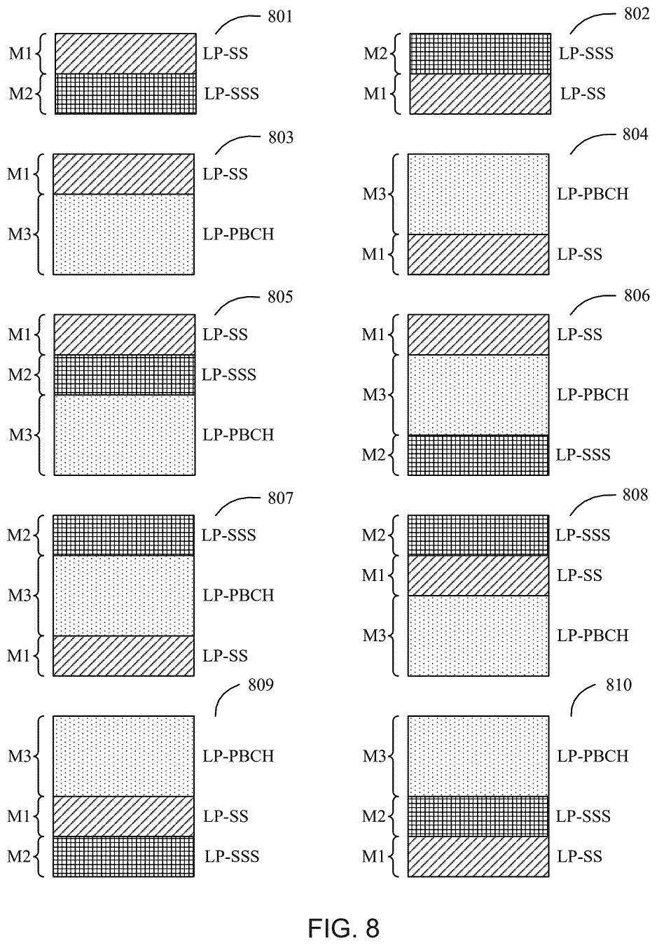

FIG. 8 illustrates an example multiplexing of components in an LP-SSB using FDM according to embodiments of the present disclosure. For example, FDM of components in an LP-SSB can be utilized by any of the UEs 111-116 of FIG. 1. This example is for illustration only and can be used without departing from the scope of the present disclosure.

For a first sub-example 801, as illustrated in FIG. 8, a LP-SSB consists of a LP-SS and a LP-SSS, as described in this disclosure, wherein the LP-SS and LP-SSS are FDMed, e.g., LP-SS occupies the first M1 RBs or subcarriers in the LP-SSB, and LP-SSS occupies the next M2 RBs or subcarriers in the LP-SSB, wherein the RBs or subcarriers are ordered from higher frequency to lower frequency.

For a second sub-example 802, a LP-SSB consists of a LP-SSS and a LP-SS, as described in this disclosure, wherein the LP-SSS and LP-SS are FDMed, e.g., LP-SSS occupies the first M2 RBs or subcarriers in the LP-SSB, and LP-SS occupies the next M1 RBs or subcarriers in the LP-SSB, wherein the RBs or subcarriers are ordered from higher frequency to lower frequency.

For a third sub-example 803, a LP-SSB consists of a LP-SS and a LP-PBCH, as described in this disclosure, wherein the LP-SS and LP-PBCH are FDMed, e.g., LP-SS occupies the first M1 RBs or subcarriers in the LP-SSB, and LP-PBCH occupies the next M3 RBs or subcarriers in the LP-SSB, wherein the RBs or subcarriers are ordered from higher frequency to lower frequency.

For a fourth sub-example 804, a LP-SSB consists of a LP-PBCH and a LP-SS, as described in this disclosure, wherein the LP-PBCH and LP-SS are FDMed, e.g., LP-PBCH occupies the first M3 RBs or subcarriers in the LP-SSB, and LP-SS occupies the next M1 RBs or subcarriers in the LP-SSB, wherein the RBs or subcarriers are ordered from higher frequency to lower frequency.

For a fifth sub-example 805, a LP-SSB consists of a LP-SS, a LP-SSS, and a LP-PBCH, as described in this disclosure, wherein the LP-SS, LP-SSS, and LP-PBCH are FDMed, e.g., LP-SS occupies the first M1 RBs or subcarriers in the LP-SSB, LP-SSS occupies the next M2 RBs or subcarriers in the LP-SSB, and LP-PBCH occupies the last M3 RBs or subcarriers in the LP-SSB, wherein the RBs or subcarriers are ordered from higher frequency to lower frequency.

For a sixth sub-example 806, a LP-SSB consists of a LP-SS, a LP-PBCH, and a LP-SSS, as described in this disclosure, wherein the LP-SS, LP-PBCH, and LP-SSS are FDMed, e.g., LP-SS occupies the first M1 RBs or subcarriers in the LP-SSB, LP-PBCH occupies the next M3 RBs or subcarriers in the LP-SSB, and LP-SSS occupies the last M2 RBs or subcarriers in the LP-SSB, wherein the RBs or subcarriers are ordered from higher frequency to lower frequency.

For a seventh sub-example 807, a LP-SSB consists of a LP-SSS, a LP-PBCH, and a LP-SS, as described in this disclosure, wherein the LP-SSS, LP-PBCH, and LP-SS are FDMed, e.g., LP-SSS occupies the first M2 RBs or subcarriers in the LP-SSB, LP-PBCH occupies the next M3 RBs or subcarriers in the LP-SSB, and LP-SS occupies the last M1 RBs or subcarriers in the LP-SSB, wherein the RBs or subcarriers are ordered from higher frequency to lower frequency.

For an eighth sub-example 808, a LP-SSB consists of a LP-SSS, a LP-SS, and a LP-PBCH, as described in this disclosure, wherein the LP-SSS, LP-SS, and LP-PBCH are FDMed, e.g., LP-SSS occupies the first M2 RBs or subcarriers in the LP-SSB, LP-SS occupies the next M1 RBs or subcarriers in the LP-SSB, and LP-PBCH occupies the last M3 RBs or subcarriers in the LP-SSB, wherein the RBs or subcarriers are ordered from higher frequency to lower frequency.

For a ninth sub-example 809, a LP-SSB consists of a LP-PBCH, a LP-SS, and a LP-SSS, as described in this disclosure, wherein the LP-PBCH, LP-SS, and LP-SSS are FDMed, e.g., LP-PBCH occupies the first M3 RBs or subcarriers in the LP-SSB, LP-SS occupies the next M1 RBs or subcarriers in the LP-SSB, and LP-SSS occupies the last M2 RBs or subcarriers in the LP-SSB, wherein the RBs or subcarriers are ordered from higher frequency to lower frequency.

For a tenth sub-example 810, a LP-SSB consists of a LP-PBCH, a LP-SSS, and a LP-SS, as described in this disclosure, wherein the LP-PBCH, LP-SSS, and LP-SS are FDMed, e.g., LP-PBCH occupies the first M3 RBs or subcarriers in the LP-SSB, LP-SSS occupies the next M2 RBs or subcarriers in the LP-SSB, and LP-SS occupies the last M1 RBs or subcarriers in the LP-SSB, wherein the RBs or subcarriers are ordered from higher frequency to lower frequency.

For one further consideration of the sub-examples of this example, the components (LP-SS, and/or LP-SSS, and/or LP-PBCH) can have same number of symbols, e.g., in term of an OFDM symbol or an OOK symbol (e.g., a segment in an OFDM symbol that corresponds to an ON or an OFF in the OOK waveform).

For another further consideration of the sub-examples of this example, although the components are FDMed without frequency domain gap(s) in between, as illustrated in FIG. 8, this disclosure also includes multiplexing pattern with potential frequency domain gap(s) in between components within the LP-SSB.

For yet another further consideration of the sub-examples of this example, M1=M2.

For yet another further consideration of the sub-examples of this example, M1=M3.

For yet another further consideration of the sub-examples of this example, M2=M3.

For yet another further consideration of the sub-examples of this example, M1 can be pre-defined in the specifications of system operation, such as M1=11, or M1=12.

For yet another further consideration of the sub-examples of this example, M1 can be configured by a higher layer parameter, such as a SIB or a dedicated RRC parameter.

For yet another further consideration of the sub-examples of this example, M2 can be pre-defined in the specifications of system operation, such as M2=11, or M2=12.

For yet another further consideration of the sub-examples of this example, M2 can be configured by a higher layer parameter, such as a SIB or a dedicated RRC parameter.

For yet another further consideration of the sub-examples of this example, M3 can be pre-defined in the specifications of system operation, such as M3=11, or M3=12.

For yet another further consideration of the sub-examples of this example, M3 can be configured by a higher layer parameter, such as a SIB or a dedicated RRC parameter.

For yet another further consideration of the sub-examples of this example, when the components of the LP-SSB are FDMed, the time domain resources for the components of the LP-SSB can be the same, e.g., occupying the same symbol(s) or slot(s). For one instance, the time domain resources (e.g., number of symbols) can be pre-defined in the specifications of system operation, e.g., 1, or 2, or 3, or 4, or 5, or 6, or 7, or 14 symbols. For another instance, the time domain resources (e.g., starting symbol and/or a number of symbols and/or slot index) can be configured by a higher layer parameter, such as a SIB or a dedicated RRC parameter.

For one example, components in the LP-SSB (e.g., LP-SS, LP-SSS, or LP-PBCH, as described in this disclosure) can be first frequency division multiplexed (FDMed) and then time division multiplexed (TDMed).

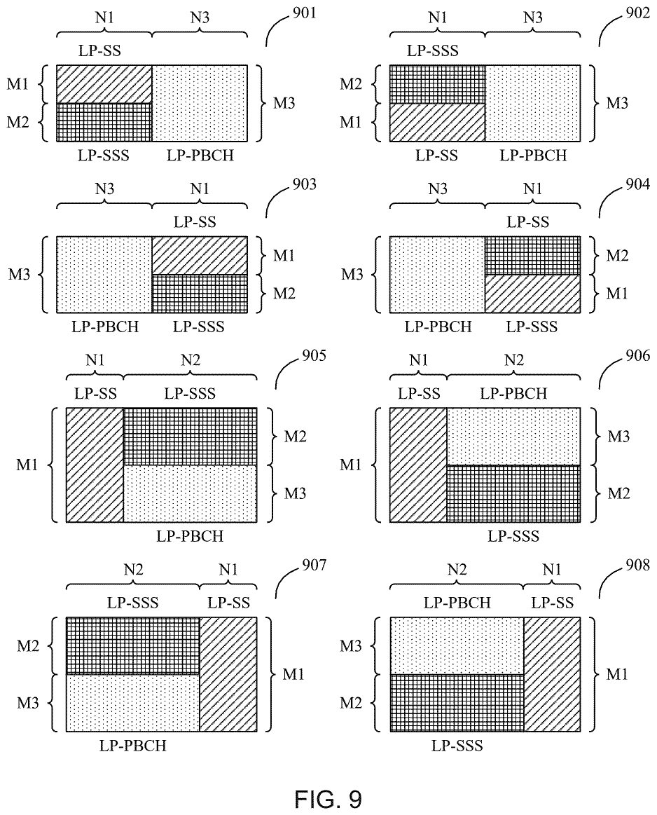

FIG. 9 illustrates an example multiplexing of components in an LP-SSB using both TDM and FDM according to embodiments of the present disclosure. For example, both TDM and FDM of components in an LP-SSB can be utilized by any of the UEs 111-116 of FIG. 1. This example is for illustration only and can be used without departing from the scope of the present disclosure.

For a first sub-example 901, as illustrated in FIG. 9, a LP-SSB consists of a LP-SS, a LP-SSS, and a LP-PBCH, as described in this disclosure, wherein the LP-SS and LP-SSS are FDMed, and further TDMed with LP-PBCH, e.g., LP-SS and LP-SSS occupies the first N1 symbols in the LP-SSB, wherein LP-SS occupies the first M1 RBs or subcarriers and LP-SSS occupies the next M2 RBs or subcarriers within the N1 symbols, and LP-PBCH occupies the next N3 symbols in the LP-SSB, with a bandwidth of M3 RBs or subcarriers.

For a second sub-example 902, a LP-SSB consists of a LP-SS, a LP-SSS, and a LP-PBCH, as described in this disclosure, wherein the LP-SSS and LP-SS are FDMed, and further TDMed with LP-PBCH, e.g., LP-SSS and LP-SS occupies the first N1 symbols in the LP-SSB, wherein LP-SSS occupies the first M2 RBs or subcarriers and LP-SS occupies the next M1 RBs or subcarriers within the N1 symbols, and LP-PBCH occupies the next N3 symbols in the LP-SSB, with a bandwidth of M3 RBs or subcarriers.

For a third sub-example 903, a LP-SSB consists of a LP-SS, a LP-SSS, and a LP-PBCH, as described in this disclosure, wherein the LP-SS and LP-SSS are FDMed, and further TDMed with LP-PBCH, e.g., LP-PBCH occupies the first N3 symbols in the LP-SSB, with a bandwidth of M3 RBs or subcarriers, and LP-SS and LP-SSS occupies the next N1 symbols in the LP-SSB, wherein LP-SS occupies the first M1 RBs or subcarriers and LP-SSS occupies the next M2 RBs or subcarriers within the N1 symbols.

For a fourth sub-example 904, a LP-SSB consists of a LP-SS, a LP-SSS, and a LP-PBCH, as described in this disclosure, wherein the LP-SSS and LP-SS are FDMed, and further TDMed with LP-PBCH, e.g., LP-PBCH occupies the first N3 symbols in the LP-SSB, with a bandwidth of M3 RBs or subcarriers, and LP-SSS and LP-SS occupies the next N1 symbols in the LP-SSB, wherein LP-SSS occupies the first M2 RBs or subcarriers and LP-SS occupies the next M1 RBs or subcarriers within the N1 symbols.

For a fifth sub-example 905, a LP-SSB consists of a LP-SS, a LP-SSS, and a LP-PBCH, as described in this disclosure, wherein the LP-PBCH and LP-SSS are FDMed, and further TDMed with LP-SS, e.g., LP-SS occupies the first N1 symbols in the LP-SSB, with a bandwidth of M1 RBs or subcarriers, and LP-SSS and LP-PBCH occupies the next N2 symbols in the LP-SSB, wherein LP-SSS occupies the first M2 RBs or subcarriers and LP-PBCH occupies the next M3 RBs or subcarriers within the N2 symbols.

For a sixth sub-example 906, a LP-SSB consists of a LP-SS, a LP-SSS, and a LP-PBCH, as described in this disclosure, wherein the LP-PBCH and LP-SSS are FDMed, and further TDMed with LP-SS, e.g., LP-SS occupies the first N1 symbols in the LP-SSB, with a bandwidth of M1 RBs or subcarriers, and LP-SSS and LP-PBCH occupies the next N2 symbols in the LP-SSB, wherein LP-PBCH occupies the first M3 RBs or subcarriers and LP-SSS occupies the next M2 RBs or subcarriers within the N2 symbols.

For a seventh sub-example 907, a LP-SSB consists of a LP-SS, a LP-SSS, and a LP-PBCH, as described in this disclosure, wherein the LP-PBCH and LP-SSS are FDMed, and further TDMed with LP-SS, e.g., LP-SSS and LP-PBCH occupies the first N2 symbols in the LP-SSB, wherein LP-SSS occupies the first M2 RBs or subcarriers and LP-PBCH occupies the next M3 RBs or subcarriers within the N2 symbols, and LP-SS occupies the next N1 symbols in the LP-SSB, with a bandwidth of M1 RBs or subcarriers.

For an eighth sub-example 908, a LP-SSB consists of a LP-SS, a LP-SSS, and a LP-PBCH, as described in this disclosure, wherein the LP-PBCH and LP-SSS are FDMed, and further TDMed with LP-SS, e.g., LP-SSS and LP-PBCH occupies the first N2 symbols in the LP-SSB, wherein LP-PBCH occupies the first M3 RBs or subcarriers and LP-SSS occupies the next M2 RBs or subcarriers within the N2 symbols, and LP-SS occupies the next N1 symbols in the LP-SSB, with a bandwidth of M1 RBs or subcarriers.

For one further consideration of the sub-examples of this example, the TDMed components (LP-SS, and/or LP-SSS, and/or LP-PBCH) can have same bandwidth, e.g., in term of RBs or subcarrier spacings.

For another further consideration of the sub-examples of this example, the unit of N1, and/or N2, and/or N3 can be either an OFDM symbol or an OOK symbol (e.g., a segment in an OFDM symbol that corresponds to an ON or an OFF in the OOK waveform).

For yet another further consideration of the sub-examples of this example, although the TDMed components are without time domain gap(s) in between, as illustrated in FIG. 9, the disclosure also includes multiplexing pattern with potential time domain gap(s) in between the TDMed components within the LP-SSB.

For yet another further consideration of the sub-examples of this example, the FDMed components (LP-SS, and/or LP-SSS, and/or LP-PBCH) can have same number of symbols, e.g., in term of an OFDM symbol or an OOK symbol (e.g., a segment in an OFDM symbol that corresponds to an ON or an OFF in the OOK waveform).

For yet another further consideration of the sub-examples of this example, although the FDMed components are without frequency domain gap(s) in between, as illustrated in FIG. 9, the disclosure also includes multiplexing pattern with potential frequency domain gap(s) in between the FDMed components within the LP-SSB.

For yet another further consideration of the sub-examples of this example, N1=N2.

For yet another further consideration of the sub-examples of this example, N1=N3.

For yet another further consideration of the sub-examples of this example, N2=N3.

For yet another further consideration of the sub-examples of this example, M1=M2.

For yet another further consideration of the sub-examples of this example, M1=M3.

For yet another further consideration of the sub-examples of this example, M2=M3.

For yet another further consideration of the sub-examples of this example, M3=M1+M2.

For yet another further consideration of the sub-examples of this example, M1=M2+M3.

For one example, components in the LP-SSB (e.g., LP-SS, LP-SSS, or LP-PBCH, as described in the disclosure) can be first time division multiplexed (TDMed) and then frequency division multiplexed (FDMed).

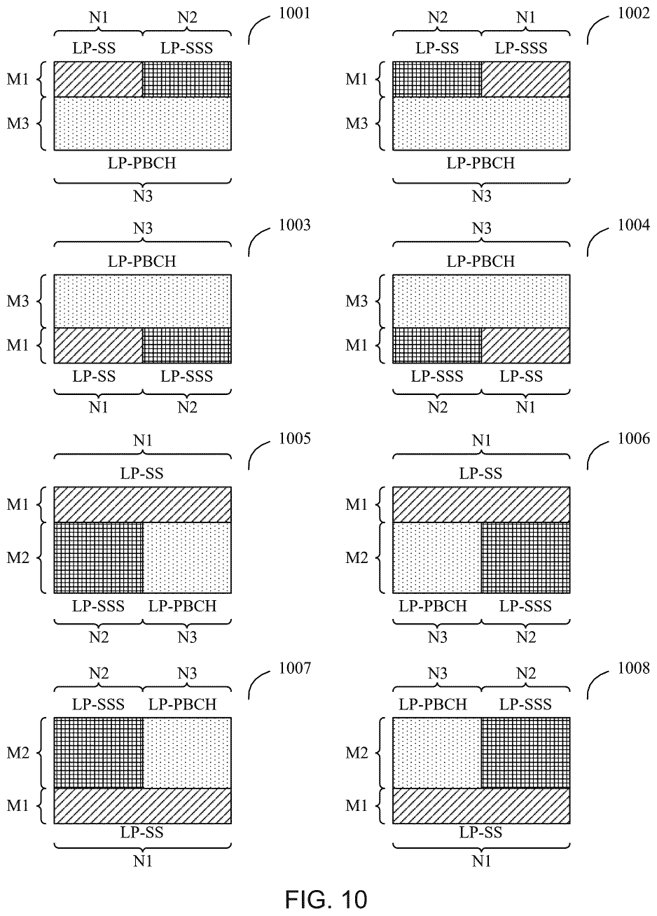

FIG. 10 illustrates another example multiplexing of components in an LP-SSB using both TDM and FDM according to embodiments of the present disclosure. For example, both TDM and FDM of components in an LP-SSB can be utilized by any of the UEs 111-116 of FIG. 1. This example is for illustration only and can be used without departing from the scope of the present disclosure.

For a first sub-example 1001, as illustrated in FIG. 10, a LP-SSB consists of a LP-SS, a LP-SSS, and a LP-PBCH, as described in this disclosure, wherein the LP-SS and LP-SSS are TDMed, and further FDMed with LP-PBCH, e.g., LP-SS and LP-SSS occupies the first M1 RBs or subcarriers in the LP-SSB, wherein LP-SS occupies the first N1 symbols and LP-SSS occupies the next N2 symbols within the M1 RBs or subcarriers, and LP-PBCH occupies the next M3 RBs or subcarriers in the LP-SSB, with N3 symbols.

For a second sub-example 1002, a LP-SSB consists of a LP-SS, a LP-SSS, and a LP-PBCH, as described in this disclosure, wherein the LP-SS and LP-SSS are TDMed, and further FDMed with LP-PBCH, e.g., LP-SSS and LP-SS occupies the first M1 RBs or subcarriers in the LP-SSB, wherein LP-SSS occupies the first N2 symbols and LP-SS occupies the next N1 symbols within the M1 RBs or subcarriers, and LP-PBCH occupies the next M3 RBs or subcarriers in the LP-SSB, with N3 symbols.

For a third sub-example 1003, a LP-SSB consists of a LP-SS, a LP-SSS, and a LP-PBCH, as described in this disclosure, wherein the LP-SS and LP-SSS are TDMed, and further FDMed with LP-PBCH, e.g., LP-PBCH occupies the first M3 RBs or subcarriers in the LP-SSB, with N3 symbols, and LP-SS and LP-SSS occupies the next M1 RBs or subcarriers in the LP-SSB, wherein LP-SS occupies the first N1 symbols and LP-SSS occupies the next N2 symbols within the M1 RBs or subcarriers.

For a fourth sub-example 1004, a LP-SSB consists of a LP-SS, a LP-SSS, and a LP-PBCH, as described in this disclosure, wherein the LP-SS and LP-SSS are TDMed, and further FDMed with LP-PBCH, e.g., LP-PBCH occupies the first M3 RBs or subcarriers in the LP-SSB, with N3 symbols, and LP-SSS and LP-SS occupies the next M1 RBs or subcarriers in the LP-SSB, wherein LP-SSS occupies the first N2 symbols and LP-SS occupies the next N1 symbols within the M1 RBs or subcarriers.

For a fifth sub-example 1005, a LP-SSB consists of a LP-SS, a LP-SSS, and a LP-PBCH, as described in this disclosure, wherein the LP-SSS and LP-PBCH are TDMed, and further FDMed with LP-SS, e.g., the LP-SS occupies the first M1 RBs or subcarriers in the LP-SSB, with N1 symbols, and LP-SSS and LP-PBCH occupies the next M2 RBs or subcarriers in the LP-SSB, wherein LP-SSS occupies the first N2 symbols and LP-PBCH occupies the next N3 symbols within the M2 RBs or subcarriers.

For a sixth sub-example 1006, a LP-SSB consists of a LP-SS, a LP-SSS, and a LP-PBCH, as described in this disclosure, wherein the LP-SSS and LP-PBCH are TDMed, and further FDMed with LP-SS, e.g., the LP-SS occupies the first M1 RBs or subcarriers in the LP-SSB, with N1 symbols, and LP-PBCH and LP-SSS occupies the next M2 RBs or subcarriers in the LP-SSB, wherein LP-PBCH occupies the first N3 symbols and LP-SSS occupies the next N2 symbols within the M2 RBs or subcarriers.

For a seventh sub-example 1007, a LP-SSB consists of a LP-SS, a LP-SSS, and a LP-PBCH, as described in this disclosure, wherein the LP-SSS and LP-PBCH are TDMed, and further FDMed with LP-SS, e.g., LP-SSS and LP-PBCH occupies the first M2 RBs or subcarriers in the LP-SSB, wherein LP-SSS occupies the first N2 symbols and LP-PBCH occupies the next N3 symbols within the M2 RBs or subcarriers, and the LP-SS occupies the next M1 RBs or subcarriers in the LP-SSB, with N1 symbols.

For an eighth sub-example 1008, a LP-SSB consists of a LP-SS, a LP-SSS, and a LP-PBCH, as described in this disclosure, wherein the LP-SSS and LP-PBCH are TDMed, and further FDMed with LP-SS, e.g., LP-PBCH and LP-SSS occupies the first M2 RBs or subcarriers in the LP-SSB, wherein LP-PBCH occupies the first N3 symbols and LP-SSS occupies the next N2 symbols within the M2 RBs or subcarriers, and the LP-SS occupies the next M1 RBs or subcarriers in the LP-SSB, with N1 symbols.

For one further consideration of the sub-examples of this example, the TDMed components (LP-SS, and/or LP-SSS, and/or LP-PBCH) can have same bandwidth, e.g., in term of RBs or subcarrier spacings.

For another further consideration of the sub-examples of this example, the unit of N1, and/or N2, and/or N3 can be either an OFDM symbol or an OOK symbol (e.g., a segment in an OFDM symbol that corresponds to an ON or an OFF in the OOK waveform).

For yet another further consideration of the sub-examples of this example, although the TDMed components are without time domain gap(s) in between, as illustrated in FIG. 10, the disclosure also includes multiplexing pattern with potential time domain gap(s) in between the TDMed components within the LP-SSB.

For yet another further consideration of the sub-examples of this example, the FDMed components (LP-SS, and/or LP-SSS, and/or LP-PBCH) can have same number of symbols, e.g., in term of an OFDM symbol or an OOK symbol (e.g., a segment in an OFDM symbol that corresponds to an ON or an OFF in the OOK waveform).

For yet another further consideration of the sub-examples of this example, although the FDMed components are without frequency domain gap(s) in between, as illustrated in FIG. 10, the disclosure also includes multiplexing pattern with potential frequency domain gap(s) in between the FDMed components within the LP-SSB.

For yet another further consideration of the sub-examples of this example, N1=N2.

For yet another further consideration of the sub-examples of this example, N1=N3.

For yet another further consideration of the sub-examples of this example, N2=N3.

For yet another further consideration of the sub-examples of this example, N3=N1+N2.

For yet another further consideration of the sub-examples of this example, N1=N2+N3.

For yet another further consideration of the sub-examples of this example, M1=M2.

For yet another further consideration of the sub-examples of this example, M1=M3.

For yet another further consideration of the sub-examples of this example, M2=M3.

For yet another further consideration of the sub-examples of this example, the determination of N1, or N2, or N3, or M1, or M2, or M3, and/or relationship of components when TDMed or FDMed can be subject to other examples of the present disclosure.

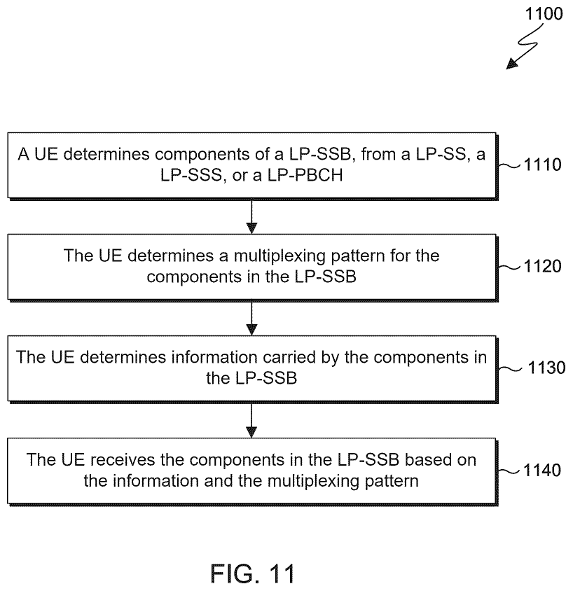

FIG. 11 illustrates an example method 1100 performed by a UE in a wireless communication system according to embodiments of the present disclosure. The method 1100 of FIG. 11 can be performed by any of the UEs 111-116 of FIG. 1, such as the UE 116 of FIG. 3, and a corresponding method can be performed by any of the gNBs 101-103 of FIG. 1, such as gNB 102 of FIG. 2. The method 1100 is for illustration only and other embodiments can be used without departing from the scope of the present disclosure.

The method 1100 begins with a UE determining components of a LP-SSB, from a LP-SS, a LP-SSS, or a LP-PBCH (1110). The UE then determines a multiplexing pattern for the components in the LP-SSB (1120). The UE then determines information carried by the components in the LP-SSB (1130). The UE then receives the components in the LP-SSB based on the information and the multiplexing pattern (1140).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to determine a first structure of a first synchronization signal block (SSB); and
a transceiver operably coupled to the processor, the transceiver configured to receive the first SSB based on the first structure,
wherein the processor is further configured to identify, based on the first SSB, an indication on whether a second SSB is present, and
wherein the transceiver is further configured to receive the second SSB in response to identification that the second SSB is present.

2. The UE of claim 1, wherein the first structure of the first SSB includes a first synchronization signal and a second synchronization signal.

3. The UE of claim 2, wherein:
the first synchronization signal and the second synchronization signal are time division multiplexed (TDMed);
the first synchronization signal and the second synchronization signal have a same subcarrier spacing; and
the first synchronization signal and the second synchronization signal have same frequency domain resources.

4. The UE of claim 2, wherein a first sequence to generate the first synchronization signal is based on (N_{ID} mod N_{SS}), where N_{ID} is a physical cell identity, and N_{SS} is a number of first sequences for the first synchronization signal.

5. The UE of claim 2, wherein a second sequence to generate the second synchronization signal is based on N_{ID}, where N_{ID} is a physical cell identity.

6. The UE of claim 2, wherein the second synchronization signal includes the indication on whether the second SSB is present.

7. The UE of claim 1, wherein the first SSB is based on a waveform for a reception with low power.

8. A base station (BS) in a wireless communication system, the BS comprising:
a processor configured to:
determine a first structure of a first synchronization signal block (SSB); and
determine, based on the first SSB, an indication on whether a second SSB is present; and
a transceiver operably coupled to the processor, the transceiver configured to:
transmit the first SSB based on the first structure; and
transmit the second SSB in response to determination that the second SSB is present.

9. The BS of claim 8, wherein the first structure of the first SSB includes a first synchronization signal and a second synchronization signal.

10. The BS of claim 9, wherein:
the first synchronization signal and the second synchronization signal are time division multiplexed (TDMed);
the first synchronization signal and the second synchronization signal have a same subcarrier spacing; and
the first synchronization signal and the second synchronization signal have same frequency domain resources.

11. The BS of claim 9, wherein a first sequence to generate the first synchronization signal is based on (N_{ID} mod N_{SS}), where N_{ID} is a physical cell identity, and N_{SS} is a number of first sequences for the first synchronization signal.

12. The BS of claim 9, wherein a second sequence to generate the second synchronization signal is based on N_{ID}, where N_{ID} is a physical cell identity.

13. The BS of claim 9, wherein the second synchronization signal includes the indication on whether the second SSB is present.

14. The BS of claim 8, wherein the first SSB is based on a waveform for a reception with a low power.

15. A method of a user equipment (UE) in a wireless communication system, the method comprising:
determining a first structure of a first synchronization signal block (SSB);
receiving the first SSB based on the first structure;
identifying, based on the first SSB, an indication on whether a second SSB is present; and
receiving the second SSB, in response to identification that the second SSB is present.

16. The method of claim 15, wherein the first structure of the first SSB includes a first synchronization signal and a second synchronization signal.

17. The method of claim 16, wherein:
the first synchronization signal and the second synchronization signal are time division multiplexed (TDMed);
the first synchronization signal and the second synchronization signal have a same subcarrier spacing; and
the first synchronization signal and the second synchronization signal have same frequency domain resources.

18. The method of claim 16, wherein:
a first sequence to generate the first synchronization signal is based on (N_{ID} mod N_{SS}), where N_{ID} is a physical cell identity, and N_{SS} is a number of first sequences for the first synchronization signal; and
a second sequence to generate the second synchronization signal is based on N_{ID}, where N_{ID} is the physical cell identity.

19. The method of claim 16, wherein the second synchronization signal includes the indication on whether the second SSB is present.

20. The method of claim 15, wherein the first SSB is based on a waveform for a reception with a low power.
